(19) United States
(12) Patent Application Publication
(10) Pub. No.: US 2012/0167009 A1
(43) Pub. Date: Jun. 28, 2012

(54) COMBINING TIMING AND GEOMETRY INFORMATION FOR TYPING CORRECTION

(75) Inventors: Douglas R. Davidson, Palo Alto, CA (US); Karan Misra, Mountain View, CA (US)

(73) Assignee: APPLE INC., Cupertino, CA (US)

(21) Appl. No.: 12/976,834

(22) Filed: Dec. 22, 2010

(51) Int. Cl. G06F 3/048

(52) U.S. Cl. 715/816

(57) ABSTRACT

Techniques to automatically correct or complete text are disclosed. A string and keystroke timing information associated with entry of the string, for example via an input device such as a keyboard, are received. A word to suggest as a correction or completion of the string is determined based at least in part on the keystroke timing information.

### BACKGROUND OF THE INVENTION

Automatic typing correction has been provided by platforms and/or applications to automatically correct and/or suggest corrections to and/or completions for typed or partially typed words. Typical approaches include detecting and suggesting an alternative for a word that does not occur in a dictionary of valid and correctly typed words. In some approaches a word for which the typed text is a commonly encountered misspelling, or in the case of auto-completion a string that forms part of a valid dictionary or a most commonly occurring corresponding dictionary entry, may be suggested. In some approaches, keyboard geometry may be considered. For example, a word that is similar to the typed text except for one or more errors associated potentially with keyboard geometry, such as differing by a letter where the correct letter is located adjacent to the typed incorrect letter on the keyboard, may be suggested.

### BRIEF DESCRIPTION OF THE DRAWINGS

Various embodiments of the invention are disclosed in the following detailed description and the accompanying drawings.

FIG. 1 is a flow diagram illustrating an embodiment of a process for using keystroke timing information to perform auto-correction and/or completion.

FIG. 2 is a flow diagram illustrating an embodiment of a process for receiving key press events.

FIG. 3 is a flow diagram illustrating an embodiment of a process for using keystroke timing information to evaluate auto-correction and/or completion candidates.

FIG. 4 is a flow diagram illustrating an embodiment of a process for adjusting to an individual user's typing speed.

FIG. 5 is a flow diagram illustrating an embodiment of a process to determine keyboard geometry information for use in auto-correction and/or completion.

FIG. 6 is a block diagram illustrating an embodiment of a system configured to use keystroke timing information to perform auto-correction and/or completion.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Using keystroke timing information to perform auto-correction and/or completion of typed text is disclosed. In various embodiments, keystroke timing information is used to identify errors such as transposed, double, and extra adjacent or nearly adjacent characters. In some embodiments, baseline information concerning typing speed is used to determine, at least in part, that the relative timing of two or more keystrokes indicates that an error has occurred. In some embodiments, possible alternatives to typed text are evaluated continuously as text is entered. A scoring algorithm is used to evaluate alternatives, and in some embodiments a higher score is assigned to an alternative associated with an error involving a double, transposed, or adjacent character if keystroke timing information indicates a higher degree of confidence that such an error has occurred. In various embodiments, keyboard geometry information may be combined with keystroke timing information to identify and/or score suggested corrections for errors.

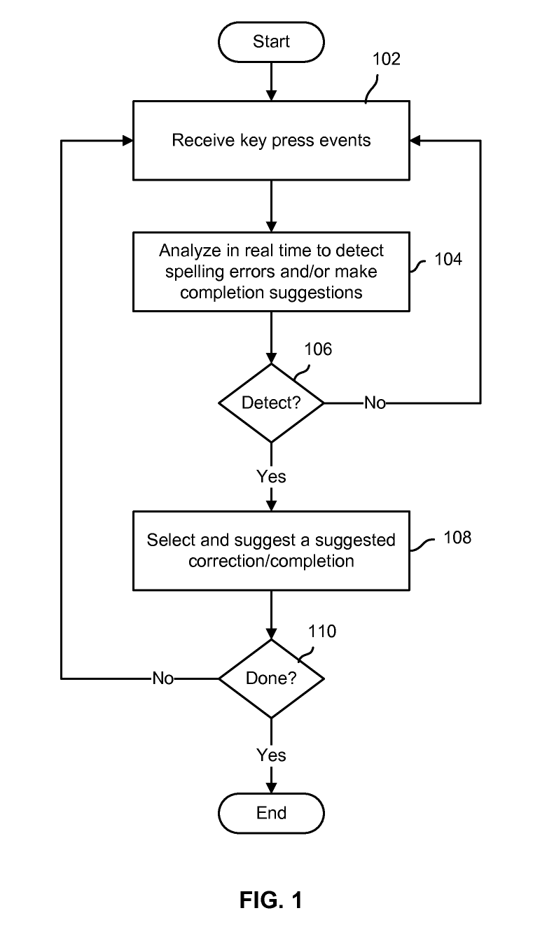

FIG. 1 is a flow diagram illustrating an embodiment of a process for using keystroke timing information to perform auto-correction and/or completion. In the example shown, as key press events are received (102) entered strings are evaluated and analyzed in real time to detect spelling errors and/or make auto-correction and/or auto-completion suggestions (104). In various embodiments, the analysis includes considering keystroke timing information, such as key down and/or key up event timestamps, to detect errors and/or suggestion corrections and/or completions. If an error or incomplete word for which a correction or suggested auto-completion is available is detected (106) a suggested correction or completion is selected and suggested (108), for example by displaying the alternative near the word in a “tip” or other pop-up and/or otherwise marking the word or partial word as one for which one or more suggested auto-replacements may be available. The process of continually monitoring keystroke events and evaluating entered text, including in light of keystroke timing information, to detect errors or partial words for which an auto-correction or completion suggestion is available, continues until done (110), for example the document is closed.

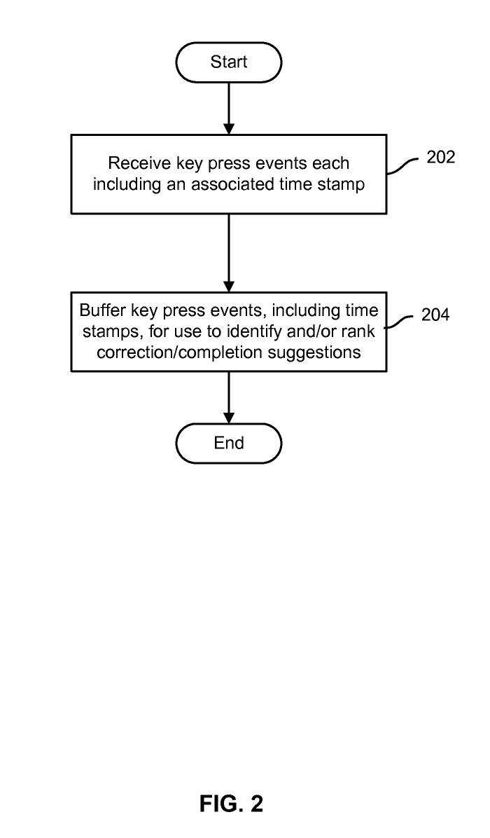

FIG. 2 is a flow diagram illustrating an embodiment of a process for receiving key press events. In various embodiments the process of FIG. 2 is used to implement 102 of FIG. 1. In the example shown, key press (down and/or up) events, each of which includes an associated event timestamp, are received (202). Key press events are buffered, including timestamp information, for use to identify and/or evaluate (for example, rank or score) correction and/or completion candidates (204).

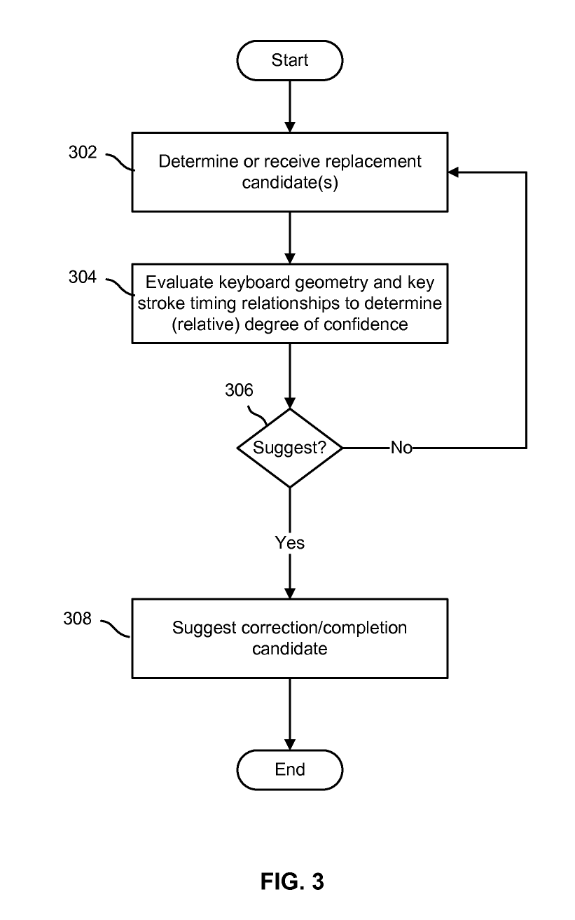

FIG. 3 is a flow diagram illustrating an embodiment of a process for using keystroke timing information to evaluate auto-correction and/or completion candidates. In the example shown, one or more replacement candidates for an entered string are determined or received (302). In some embodiments, replacement candidates are determined by finding in a dictionary or other store of replacement candidates one or more entries corresponding to an entered string. Keyboard geometry (for example, knowledge of which keys are adjacent to which others on the keyboard, or which keys are on opposite sides of the keyboard and therefore likely to be struck by different hands, potentially in the wrong order) and keystroke timing information (e.g., how close in time two keys were struck) are evaluated in real time to determine a degree of confidence (or other score) for each suggestion/replacement candidate. If a candidate receives a score greater than a suggestion (or replacement) threshold (306), the candidate is suggested to the user (or, in some embodiments and/or configuration, automatically entered as a replacement) (308).

In some embodiments, keystroke timing information is evaluated at least in part by comparing the timing of observed keystroke events with a baseline. For example, in some embodiments a baseline typing speed data is determined and used as a baseline to which to compare observed keystroke events. If the observed time difference between successive events is less than a corresponding baseline, for example for the same character pair, by more than a threshold amount, then a replacement candidate associated with an error with respect to the character pair, such as a double strike, transposition, or other error, is ranked more highly as a potential replacement for the string entered by the user. For example, if the string “theere” is entered and the time between the keystrokes “ee” is less than an associated baseline by more than a threshold amount, the replacement candidate “there” may be assigned a higher score. In some embodiments, the baseline is at least initially a general baseline determined in advance for a typical typist. In some embodiments, a custom or customized baseline is or may optionally be determined for an individual user. The user's typing speed is monitored and adjustments to the baseline and/or associated thresholds are made if the user's typing speed is observed to be slower or faster than that of the “typical” user reflected in the default baseline. Or, in some embodiments no default is provided and instead a test text is typed by the user to determine a baseline for the user from scratch.

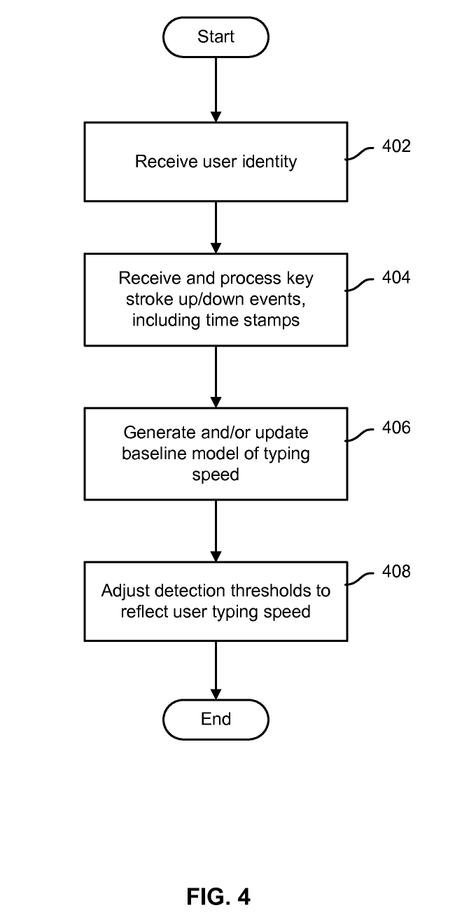

FIG. 4 is a flow diagram illustrating an embodiment of a process for adjusting to an individual user's typing speed. In the example shown, a user's identity is received (402), for example through a login process. Keystroke events, such as key down and up events, and associated timestamps are received (404). The keystroke events are processed to determine a baseline model of the user's typing speed, or in some embodiments to update a default or other existing baseline (406). Detection thresholds are adjusted to reflect the individual user's observed typing speed (408). For example, if the user is observed to type very quickly, in some embodiments thresholds are adjusted such that two keys must be typed more closely together in time by that user, than for another (e.g., typical) user for a keystroke timing related replacement candidate score enhancement or other adjustment to be applied.

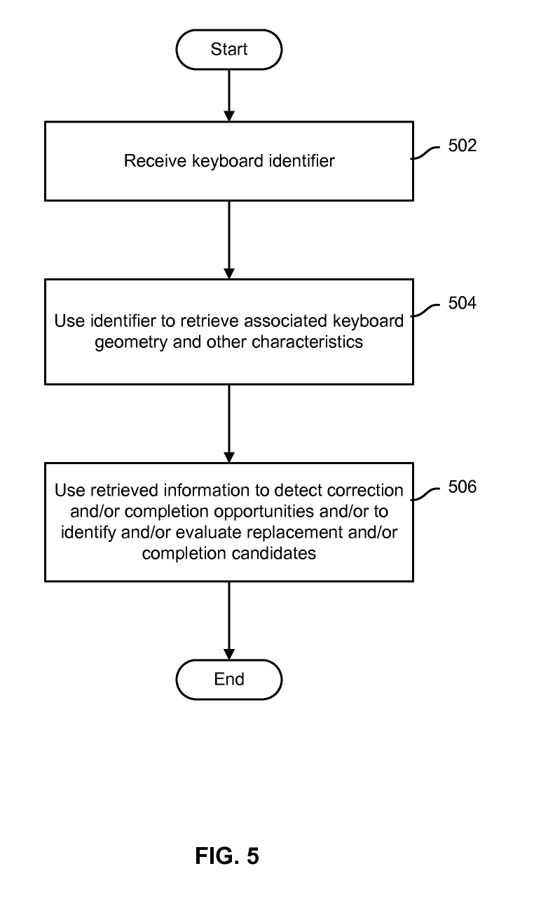

FIG. 5 is a flow diagram illustrating an embodiment of a process to determine keyboard geometry information for use in auto-correction and/or completion. In the example shown, a keyboard identifier is received (502). For example, an identifier received in connection with a USB keyboard being present at startup or subsequently plugged in is received. The keyboard identifier is used to retrieve associated keyboard geometry information and/or other characteristics (504). The retrieved information is used to detect errors and/or completion candidates, for example by using keyboard-specific geometry information to determine or adjust detection thresholds and/or score enhancements for replacement candidates associated with adjacent keys or keys likely to be struck by different hands (506). In some embodiments, detection (or score enhancement) thresholds associated with keystroke timing are or may be different for different types of keyboard. For example, a shorter interval between keystrokes entered without error might be expected if keys are located nearer to one another, so the detection threshold for a double or extra keystroke might be shorter for a smaller keyboard. On the other hand, a very small keyboard, such as one with small keys and/or keys very close to one another, might be observed and/or expected to result in more double stroke type errors, and detection thresholds in some embodiments are adjusted accordingly, for example to make it relatively more likely that a replacement candidate associated with a double strike error will be suggested.

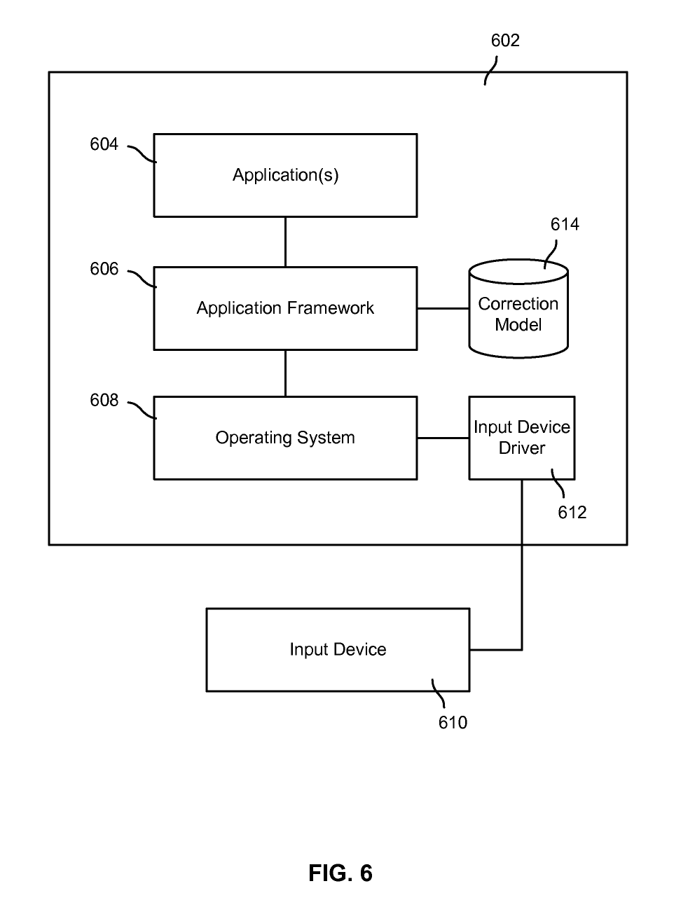

FIG. 6 is a block diagram illustrating an embodiment of a system configured to use keystroke timing information to perform auto-correction and/or completion. In the example shown, a system 602 includes one or more applications 604 running in an application framework 606 running on an operating system 608. In various embodiments, the application(s) 602, application framework 604, and operating system 606 comprise computer instructions stored in a memory or other storage comprising system 602 and executed by one or more processors comprising system 602. An input device 610 is connected to (or in some embodiments comprises an integrated part of) system 602 and is used by a user to provide input, via an input device driver 612, to operating system 608 of system 602. In some embodiments, input device 610 comprises a hardware or other keyboard. Keystrokes made by a user are interpreted by input device driver 612 which provides keystroke event information to operating system 608. Application framework 606 receives keystroke event information from operating system 608, including for each event an associated timestamp or other timing information. The application framework 606 analyzes the keystroke event information in light of a correction model 614 to determine and/or evaluate candidates for auto-correction and/or completion. In various embodiments, correction model 614 is stored in a memory or other storage comprising system 602. As keystroke information is received, entered strings and associated keyboard geometry and keystroke timing information are evaluated, as described herein, to identify and evaluate to suitability for suggestion of replacement candidates. If a replacement candidate having higher than a threshold degree of confidence or other score is identified, the replacement candidate is selected to be suggested or, in some embodiments and/or if configured, to be used automatically to replace the string entered by the user via the input device 610. In some embodiments, the application framework 604 is configured to provide to applications 602, via an API, an auto-correction service configured to suggest replacement candidates for strings entered by a user in the context of an application running on the application framework. The application(s) may be configured by their respective developers to access and use the service, and if so determine the manner to present and/or otherwise use replacement suggestions received from the application framework 604 via the API.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of correcting or completing text, comprising:
receiving a string and keystroke timing information associated with entry of the string; and
determining based at least in part on the keystroke timing information a word to suggest as a correction or completion of the string.

2. The method of claim 1, further comprising determining that the string is not recognized as a complete and correctly spelled word.

3. The method of claim 1, wherein the string is entered using a keyboard.

4. The method of claim 3, wherein the keystroke timing information includes for each of two or more characters comprising the string a corresponding timestamp associated with entry of that character using the keyboard.

5. The method of claim 3, wherein the keystroke timing information is evaluated at least in part in light of a keyboard geometry information.

6. The method of claim 5, wherein the keyboard geometry information comprises information specific to the keyboard used to enter the string.

7. The method of claim 6, further comprising receiving an identifier associated with the keyboard and using the identifier to obtain the keyboard geometry information specific to the keyboard used to enter the string

8. The method of claim 1, wherein the string and the keystroke timing information are received by an application framework configured to provide to an application running on the application framework an auto-correction service.

9. The method of claim 1, wherein determining based at least in part on the keystroke timing information a word to suggest as a correction or completion of the string includes assigning to a replacement candidate a score determined based at least in part on the keystroke timing information.

10. The method of claim 9, wherein assigning to a replacement candidate a score determined based at least in part on the keystroke timing information includes assigning to a replacement candidate associated with a typing error involving adjacent keys a higher score in the event an interval between striking of the adjacent keys is less than a prescribed threshold.

11. The method of claim 9, assigning to a replacement candidate a score determined based at least in part on the keystroke timing information includes assigning to a replacement candidate associated with a typing error involving keys on opposite sides of a keyboard a higher score in the event an interval between striking of the keys on opposite sides of the keyboard is less than a prescribed threshold.

12. The method of claim 9, assigning to a replacement candidate a score determined based at least in part on the keystroke timing information includes assigning to a replacement candidate associated with a typing error involving striking keys out of order a higher score in the event an interval between striking of the associated keys is less than a prescribed threshold.

13. The method of claim 9, further comprising suggesting the replacement candidate to replace the received string in the event the score is greater than a suggestion threshold.

14. The method of claim 1, wherein the keystroke timing information is evaluated in light of a baseline typing speed.

15. The method of claim 14, wherein the baseline typing speed comprises a personal baseline associated with a user.

16. The method of claim 15, further comprising determining and storing the personal baseline for the user.

17. The method of claim 14, wherein evaluating the keystroke timing information in light of a baseline typing speed includes adjusting a detection threshold to reflect the baseline typing speed.

18. The method of claim 17, wherein the detection threshold comprises a time between keystrokes and adjusting the detection threshold to reflect the baseline typing speed comprises reducing the inter-keystroke time threshold in the event the baseline typing speed is faster than a default or other previous speed on which the unadjusted detection threshold is based.

19. A system configured to correct or complete text, comprising:
an input device configured to receive a sequence of user inputs each associated with one or more characters comprising a string; and
a processor coupled to the input device and configured to:
receive a string entered via the input device and associated keystroke timing information; and
determine based at least in part on the keystroke timing information a word to suggest as a correction or completion of the string.

20. The system of claim 19, wherein the input device comprises a keyboard.

21. The system of claim 19, wherein the keystroke timing information includes for each of two or more characters comprising the string a corresponding timestamp associated with entry of that character using the keyboard.

22. The system of claim 19, wherein the keystroke timing information is evaluated at least in part in light of a keyboard geometry information.

23. The system of claim 19, wherein the processor is configured to determine the word to suggest as a correction or completion of the string at least in part by assigning to a replacement candidate a score determined based at least in part on the keystroke timing information.

24. The system of claim 19, wherein the processor is configured to evaluate the keystroke timing information in light of a baseline typing speed.

25. A computer program product for correcting or completing text, the computer program product being embodied in a non-transitory computer readable storage medium and comprising computer instructions for:
receiving a string and keystroke timing information associated with entry of the string; and
determining based at least in part on the keystroke timing information a word to suggest as a correction or completion of the string.
